(19) United States
(12) Patent Application Publication
(10) Pub. No.: US 2016/0361810 A1
(43) Pub. Date: Dec. 15, 2016

(54) LOOP-HANDLED PLIERS

(71) Applicant: Bob Roberts, Pendleton, OR (US)

(72) Inventor: Bob Roberts, Pendleton, OR (US)

(21) Appl. No.: 15/179,562

(22) Filed: Jun. 10, 2016

Related U.S. Application Data
(60) Provisional application No. 62/174,848, filed on Jun. 12, 2015.

(51) Int. Cl. B25G 1/10; B25G 1/12; B25B 7/02; B25B 7/22

(52) U.S. Cl. CPC B25G 1/102; B25B 7/22; B25G 1/12; B25B 7/02

(57) ABSTRACT

In one embodiment, a pair of loop-handled pliers includes a first lever arm and a second lever arm and a pivot. The first and second lever arms may be connected to each other via the pivot. The pliers may include an upper jaw disposed on a distal end of the first lever arm. The upper jaw may include a first grasping surface. The pliers may include a lower jaw disposed on a distal end of the second lever arm. The lower jaw may include a second grasping surface. The second grasping surface may oppose the first grasping surface. The pliers may include a first loop handle disposed at a proximal end of the first lever arm. The first loop handle may curve back and connect with itself. The pliers may include a second loop handle disposed at a proximal end of the second lever arm. The second loop handle may curve back and connect with itself.

### CROSS REFERENCE TO RELATED APPLICATIONS

This application claims priority to U.S. Provisional Application, Ser. No. 62/174,848, filed on Jun. 12, 2015, which is hereby incorporated by reference for all purposes.

### BACKGROUND

The present disclosure relates generally to hand tools. In particular, hand tools for pinching and/or grasping are described.

Hand tools have long been a key enabler of industrialization and are critical devices for a broad array of skilled tradesmen such as electricians, woodworkers, and mechanics, to name a few. Common types of hand tools include cutting tools, fastening tools and pinching/grasping tools. Pliers are perhaps the most important and well known pinching/grasping tools.

Known pliers are not entirely satisfactory for the range of applications in which they are employed. For example, both hands of the user or awkward and un-ergonomic hand contortions may be required in order to open the jaws of existing pliers. Needing to use both hands limits the user's abilities. Awkward hand contortions can lead to pain and discomfort and can limit the user's precision in using the hand tool. Indeed, conventional pliers may prove to be too clumsy and unwieldy for fine motor applications.

In addition, conventional pliers are prone slip from the hands of the user when being used. The tendency for conventional pliers to slip from the hands of the user is especially prevalent in wet or slippery applications like fishing or lineman work in inclement weather. In fishing applications, fisherman use pliers to remove a hook from a fishes' mouth and the pliers slipping from the fisherman's hands can cause the pliers to fall into the water and be permanently lost. In lineman applications, pliers slipping from the lineman's grip can cause a potentially dangerous condition for workers below or for the lineman himself given the risk of electric shock form imprecise or inadvertent actions.

Thus, there exists a need for pliers that improve upon and advance the design of known pliers. Examples of new and useful pliers relevant to the needs existing in the field are discussed below.

### SUMMARY

In one embodiment, a pair of loop-handled pliers comprises a first lever arm and a second lever arm and a pivot. The first and second lever arms may be connected to each other via the pivot. The pliers may include an upper jaw disposed on a distal end of the first lever arm. The upper jaw may include a first grasping surface. The pliers may include a lower jaw disposed on a distal end of the second lever arm. The lower jaw may include a second grasping surface. The second grasping surface may oppose the first grasping surface. The pliers may include a first loop handle disposed at a proximal end of the first lever arm. The first loop handle may curve back and connect with itself. The pliers may include a second loop handle disposed at a proximal end of the second lever arm. The second loop handle may curve back and connect with itself.

### BRIEF DESCRIPTION OF THE DRAWINGS

FIG. 1 is a side view of a first embodiment of loop handled pliers including snipe-nose pinching jaws, shown in a closed position.

FIG. 2 is a side view of the loop handled pliers of FIG. 1 showing the snipe-nose pinching jaws in an open position.

FIG. 3 is a side view of a second embodiment of loop handled pliers including flat-nose jaws.

FIG. 4 is a top view of the loop handled pliers of FIG. 3.

FIG. 5 is a side view of a third embodiment of loop handled pliers including loop handles sized to accept all the fingers of the user.

FIG. 6 is an opposite side view of the loop handled pliers of FIG. 5.

### DETAILED DESCRIPTION

The disclosed loop handled pliers well become better understood through review of the following detailed description in conjunction with the figures. The detailed description and figures provide merely examples of the various inventions is described herein. Those skilled in the art will understand that the disclosed examples may be varied, modified, and altered without departing from the scope of the inventions described herein. Many variations are contemplated for different applications and design considerations; however, for the sake of brevity each and every contemplated variation is not individually described in the following detailed description.

Throughout the following detailed description, a variety of examples of loop handled pliers are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

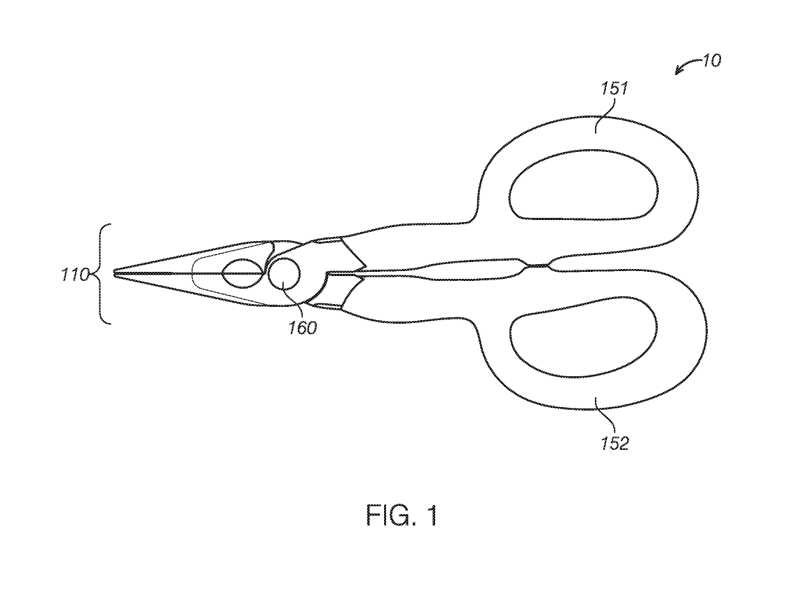

With reference to FIG. 1 a first example of a loop handled pliers 10, will now be described. Loop handled pliers 10 function to grasp, pinch, crimp and/or cut a variety of materials, including metal, plastics, wood and composites, to name a few. Additionally or alternatively, loop handled pliers 10 can be used to insulation from wire.

Loop handled pliers 10 address many of the shortcomings existing with conventional pliers. For example, loop handled pliers 10 may be operated effectively with one hand. Further, loop handled pliers 10 are retained more securely in the user's hand than conventional pliers. Additionally, loop handled pliers 10 may be more precisely controlled than conventional pliers.

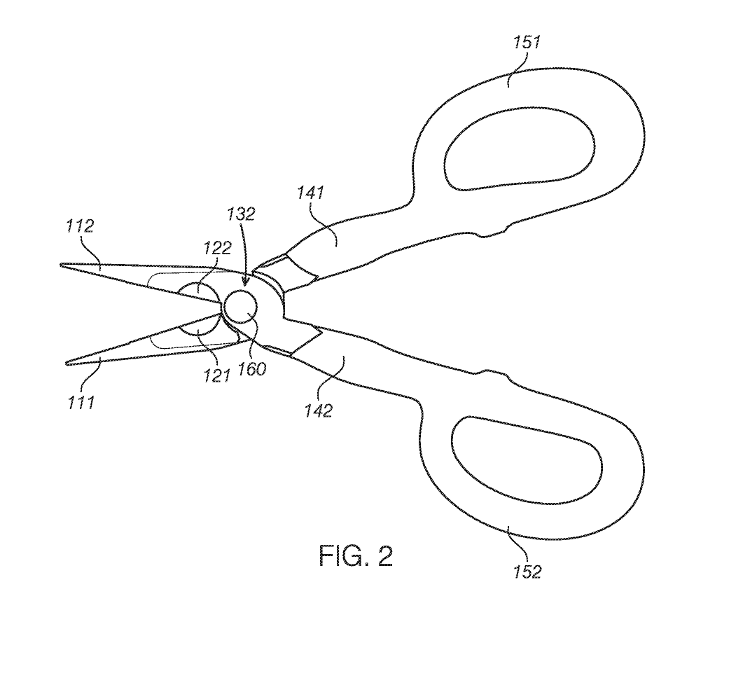

As shown in FIGS. 1-2, a first embodiment of loop handled pliers 10 includes a head portion 110, a pivot 160, and loop handles 151, 152. The head portion of the embodiment of FIG. 1 includes snipe-nose jaws 111, 112 and cutting edges 121, 122. In other embodiments, the loop handled pliers may include a head portion having other features such as flat-nose jaws,crimping elements, and/or stripping elements.

As shown in FIG. 2, upper jaw 112 includes a first grasping surface 116. Similarly, lower jaw 111 includes a second grasping surface 115. First grasping surface 115 opposes second grasping surface 116. First and second grasping surfaces 115, 116 may include jagged teeth to facilitate gripping. The teeth of first and second grasping surfaces 115, 116 may interlock.

In the illustrated embodiment of FIGS. 1-2, lower jaw 111 is connected to upper loop handle 151 via a lever arm 142. As used herein the terms “upper” and “lower” are relative to the orientation of the loop handled pliers and not meant to limit the use of the pliers. Lever arm 142 includes a pivot recess 132 configured to accept pivot 160. Upper jaw 112 is configured in a similar manner to lower jaw 111, being connected to lower loop handle 151 via lever arm 141 and having a pivot recess (not pictured) configured to accept pivot 160.

As can be seen in FIGS. 1-2 the loop handles 151, 152 are each configured to accept one or more fingers of one hand of a user. As can be seen, the loop handles 151, 152 form complete loops into which one or more fingers may be securely inserted. Thus, the user may both close and open the jaws of the loop handled pliers using only one hand, similar to operation of a pair of scissors.

In the illustrated embodiment of FIGS. 1-2 the loop handles 151, 152 include a rubberized coating. The rubberized coating may provide enhanced grip and/or insulation to prevent electric shock. In other embodiments, the loop handles may be bare or coated with any other suitable material.

In the illustrated embodiment, the loop handles 151, 152 are symmetrical mirror images of each other. Symmetrical loop handles may allow for ambidextrous use of the loop handled pliers. In other embodiments, the loop handles may be asymmetrical, e.g., a first loop handle may be sized to accept only the thumb of the user while a second loop handle may be sized to accept two or more digits of the user.

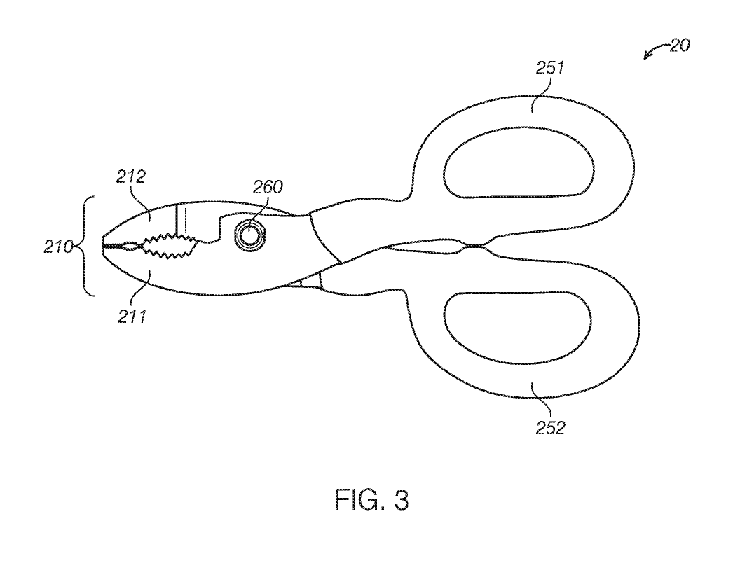

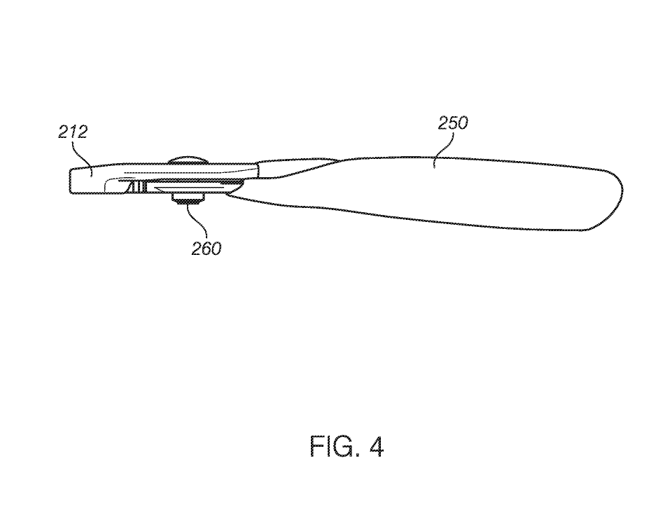

Turning attention to FIGS. 3-4, a second embodiment of loop handled pliers 20 will now be described. Loop handled pliers 20 include many similar or identical features to loop handled pliers 10. Thus, for the sake of brevity, each feature of loop handled pliers 20 will not be redundantly explained. Rather, key distinctions between loop handled pliers 20 and loop handled pliers 10 will be described in detail and the reader should reference the discussion above for features substantially similar between the two pairs of pliers.

As can be seen in FIG. 3, loop handled pliers 20 include a head portion 210, a pivot 260, and loop handles 251, 252. The head portion 210 of loop handled pliers 20 includes flat-nose jaws 211, 212. As can be seen, flat nose jaws 211, 212 include jagged teeth formed on the grasping surfaces 215, 216 of the jaws. As described above the head portion may include any number of alternative or additional features such as cutting element, crimping elements, and/or stripping elements, among others.

As shown in FIG. 3, upper jaw 212 includes a first grasping surface 216. Similarly, lower jaw 211 includes a second grasping surface 215. First grasping surface 215 opposes second grasping surface 216.

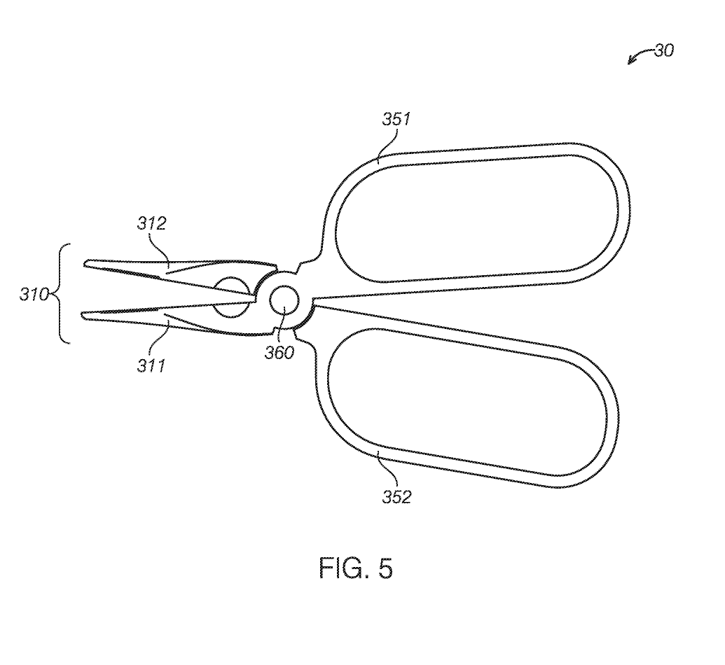

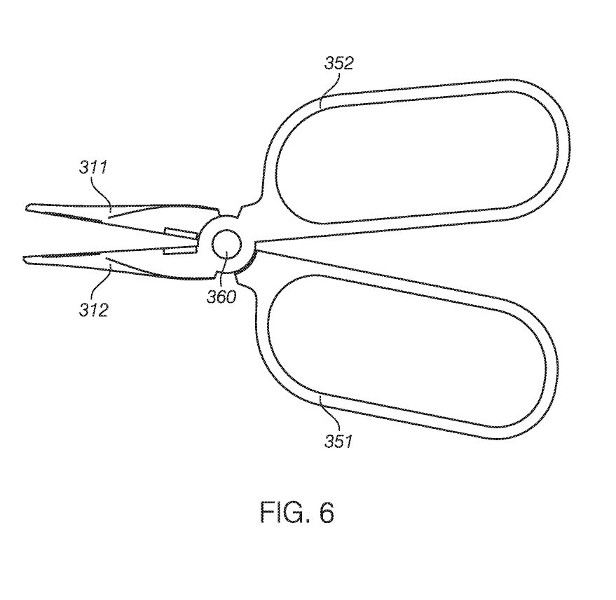

Turning attention to FIGS. 5-6, a third embodiment of loop handled pliers 30 will now be described. Loop handled pliers 30 include many similar or identical features to loop handled pliers 10. Thus, for the sake of brevity, each feature of loop handled pliers 30 will not be redundantly explained. Rather, key distinctions between loop handled pliers 30 and loop handled pliers 10 will be described in detail and the reader should reference the discussion above for features substantially similar between the two pairs of pliers.

As can be seen in FIGS. 5-6, loop handled pliers 30 include a head portion 310, a pivot 360, and loop handles 351, 352. Head portion 310 comprises an upper jaw 312 and a lower jaw 311. As can be seen, each of loop handles 351, 352 are sized to accept all four fingers opposite the user's thumb such that user may engage his entire hand in the loop handled pliers 30. Such complete engagement may allow even greater control and/or grasping strength to be exerted via the loop handled pliers.

As shown in FIG. 5, upper jaw 312 includes a first grasping surface 316. Similarly, lower jaw 311 includes a second grasping surface 315. First grasping surface 315 opposes second grasping surface 316.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A pair of pliers, comprising:
a first lever arm connected to a second lever arm via a pivot;
an upper jaw disposed on a distal end of the first lever arm;
wherein the upper jaw includes a first grasping surface;
a lower jaw disposed on a distal end of the second lever arm;
wherein the lower jaw includes a second grasping surface; and
wherein the second grasping surface opposes the first grasping surface;
a first loop handle disposed at a proximal end of the first lever arm, wherein the first loop handle curves back and connects with itself; and
a second loop handle disposed at a proximal end of the second lever arm, wherein the second loop handle curves back and connects with itself.

2. The pliers of claim 1, wherein the first loop handle is configured to receive two or more of a user's fingers.

3. The pliers of claim 1, wherein the first loop handle is configured to receive all four fingers opposite a user's thumb.

4. The pliers of claim 1, wherein the first and second loop handles are symmetrical to each other.

5. The pliers of claim 1, wherein the first and second loop handles are asymmetrical to each other.

6. The pliers of claim 1, wherein the first and second loop handles are covered with a rubberized

7. The pliers of claim 1, wherein the upper and lower jaws are snipe nose jaws.

8. The pliers of claim 1, wherein the upper and lower jaws are flat nose jaws.

9. The pliers of claim 1, wherein the upper and lower jaws are snipe nose jaws.

10. The pliers of claim 1 wherein the first and second grasping surfaces comprise interlocking teeth.
